(19) United States
(12) Patent Application Publication
(10) Pub. No.: US 2016/0155152 A1
(43) Pub. Date: Jun. 2, 2016

(54) GEOGRAPHICALLY-ORIENTED PROFILE-BASED OBJECT ASSISTANCE

(71) Applicant: salesforce.com, inc., San Francisco, CA (US)

(72) Inventor: Charles Hart ISAACS, San Jose, CA (US)

(73) Assignee: salesforce.com, inc., San Francisco, CA (US)

(21) Appl. No.: 14/997,091

(22) Filed: Jan. 15, 2016

Related U.S. Application Data
(62) Division of application No. 13/924,779, filed on Jun. 24, 2013.
(60) Provisional application No. 61/664,486, filed on Jun. 26, 2012.
(60) Provisional application No. 61/757,830, filed on Jan. 29, 2013.
(60) Provisional application No. 61/701,423, filed on Sep. 14, 2012.

(51) Int. Cl. G06Q 30/02

(52) U.S. Cl. CPC G06Q 30/0261; G06Q 30/0255; G06Q 30/0267

(57) ABSTRACT

The technology disclosed relates to connecting a user's location via a location mediation server with indications of interest in products and product groups and in real time. An application executing on a user's mobile computing device supplies a location. The location mediation server works with the application, using various allocations of effort, to match current locations to sales environments that set the product(s) of interest and, in some implementations, to product exemplars outside sales environments.

### RELATED APPLICATION

This application is a divisional application of U.S. patent application Ser. No. 13/924,779 entitled, “Geographically-oriented Profile-Based object Assistance,” filed Jun. 24, 2013 which claims the benefit of three U.S. provisional Patent Applications, including: No. 61/664,486, entitled, “Geographically-Oriented Profile-Based Object Assistance,” filed 26 Jun. 2012; No. 61/757,830, entitled, “Lifecycle Tracking Fingerprint,” filed 29 Jan. 2013; No. 61/701,423, entitled, “System and Method for Anticipating User Activity,” filed 14 Sep. 2012. It is related to U.S. provisional Patent Application No. 61/813,052, entitled, “System and Method for Connected Object Lifecycles,” filed 17 Apr. 2012. All of these related applications are hereby incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed inventions.

The technology disclosed relates to connecting a user's location via a location mediation server with indications of interest in products and product groups and in real time. An application executing on a user's mobile computing device supplies a location. The location mediation server works with the application, using various allocations of effort, to match current locations to sales environments that set the product(s) of interest and, in some implementations, to product exemplars outside sales environments.

Existing location aware applications have not combined location information with product of interest data stored in a database as a result of the user's previous actions. Therefore, an opportunity arises to extend the use of location data for the benefit of users by providing a flexible approach to user-product communication using mobile technology. Improved user experience and higher customer satisfaction and retention may result.

A combination of location information and product information data can be used to provide a user with real time alerts when they are close to a product in which they are interested in purchasing. Increasingly wide-spread use of mobile devices has made it highly desirable for product vendors to enable their products to directly communicate with users via these mobile devices.

### SUMMARY

The technology disclosed relates to connecting a user's location via a location mediation server with indications of interest in products and product groups and in real time. An application executing on a user's mobile computing device supplies a location. The location mediation server works with the application, using various allocations of effort, to match current locations to sales environments that set the product(s) of interest and, in some implementations, to product exemplars outside sales environments.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 shows an example environment in which the technology disclosed may be used.

FIG. 2 shows data that can be maintained in a product group.

FIG. 3 is a high level flowchart of example processes in the system.

FIG. 4 is an example of a database schema.

FIG. 5 is an example showing a tangible and an intangible object connected to the environment of FIG. 1.

FIG. 6 is an example of a lifecycle for an online ad campaign.

FIG. 7 is an example showing how an ad campaign propagates as it is viewed by users.

FIG. 8 is an example of tracking objects in an ad campaign.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

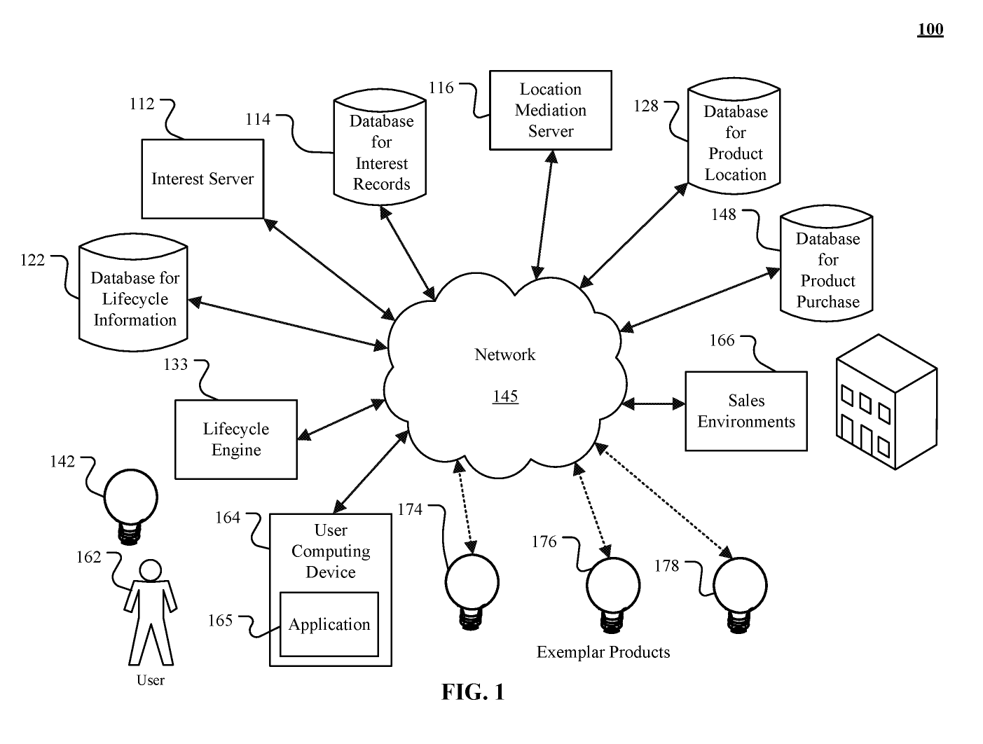

FIG. 1 illustrates a block diagram of an example environment 100 in which an interest server and location mediation server technologies can be used. The environment 100 includes a user computing device 164, an interest server 112, an interest records database 114, a location mediation server 116, and a product location database 128. The environment also includes a communication network 145 that allows communication among the various components in the environment 100. It further includes sales environments 166 with their own servers and communication components at which products of interest 142 are available to users 162. It depicts product exemplars 174, 176, 178 in a product exemplar environment outside a sales environment and which may include a temporary location. While sales environments almost always include product exemplars, the exemplars 174, 176 or 178 are separately called out to indicate that they are outside the normal sales environment 166.

In one implementation, the network 145 includes the Internet. The network can also utilize dedicated or private communication links that are not necessarily part of the Internet. In one implementation the network 145 uses standard communication technologies, protocols and/or inter-process communication technologies.

During operation the user 162 interacts with the interest server 112 and the location mediation server 116 through the user computing device 164 and an app or application 165 running on the device. The client (user) computing device 164, the interest server 112, location mediation server 116 and servers in the sales environment 166 each include memory for storage of data and software applications, processor(s) for accessing data and executing applications, and components that facilitate communication over communications network 145.

The user computing device 164 executes an application 165 that allows the user to interact with the interest server and location mediation server. This application could be a web browser. For many platforms, a custom application adapted to a mobile device form factor may perform better than a browser. The user computing device 164 can be a stationary device such as a desktop computer, set-top box, workstation or other computing appliance. For mobile applications, it may be a mobile communications device such as a smartphone, PDA, tablet, or laptop.

Databases for interest records 114, product location 128, product purchase 148 and lifecycle information 122 can be maintained on database servers, including multi-tenant database servers. These databases may be maintained on separate systems or aggregated onto a common system or common database. They can be centralized or distributed. They can be implemented using any kind of persistent memory, including rotating and solid state memories.

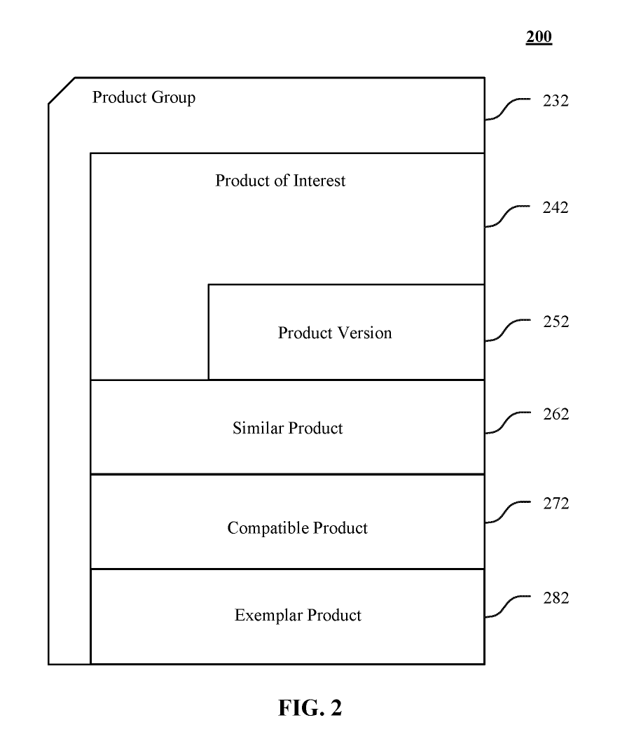

The interest server 112 receives an indication of interest from a user device 164 that indicates interest in a product 142. The interest server 112 can be repeatedly invoked for different user interests. The interest server can obtain user data from an interest database 114. Interest in a particular product 142 can be expanded by the interest server into a product group interest 242, as illustrated in FIG. 2.

The database for lifecycle information 122 can be used to track the status of a product from initial interest (user considering purchasing the product) to purchase and then to owner status, in which case the service or operational status of the product may be tracked. In this case, the status of initial interest can be obtained from a user registration of interest online and the record of purchase can be obtained from a point-of-sale (POS) terminal when the user buys the product. After purchase, the object status, as in the case of a washing machine, can be updated to service. Thus there is a natural transition in status from initial interest to purchase to service.

FIG. 2 is a data structure for a product group that includes the product of interest. In addition, the product group may include versions of the product of interest 252, products similar to the products of interest 262 and products compatible with the products of interest 272. For instance, an expressed interest in a car might result in generation of a product interest group 242 that includes the particular car as the product of interest 142, model versions of the car 252, and other cars in the same class 262. The other cars can be produced by a different manufacturer than the car of interest. The product group interest 242 may also include compatible products 272 such as automobile insurance or an extended warranty. Additionally, the product group may contain specific information related to exemplar products 282, such as known instances of the product that may provide opportunities for user interaction.

Returning to FIG. 1, the indication of interest may be the result of online browsing, using a smart phone application to image a barcode or 2-D code, entry of requests through an interactive voice response system, or another opt-in process that the user controls. In some implementations, the user's interest may be inferred and a product interest record 142 created on the interest server 112 in response to the inference. For instance, a user “friending” or “liking” a product on a manufacturer's social site may create an inference of interest in the product.

The user computing device 164 interacts with the location mediation server 116 by directly providing location information or by checking in upon arrival at a location. Location information can be obtained from GPS or GNNS location technology. Alternatively, this can be obtained from identification of wireless access points in an environment, using a database such as Skyhook. Private location services are also beginning to emerge. In some circumstances, triangulation from cellular networks or other cellular-implemented technology can provide a location. Checking in upon arrival at a location is an alternative that can be automatic or manual. An application running on the user computing device 164 can sense arrival at a location and automatically check in. Alternatively, the user can carry out the check-in process.

The location mediation server 116 interacts with a product location database 128 to relate the location of the user number 162 to the locations of sales environments 166 at which products of interest 142 are being sold. Either the location mediation server 116 or the application 165 can determine if the user is currently approaching or located at a sales environment selling the product of interest.

In one implementation, the user computing device 164 provides frequent location data updates to the location mediation server 116. The location media server 116 compares the location of the user computing device 164 to known sales environment locations in the product location database for products of interest and product groups.

Timing for display of a message or alert to a user depends on how quickly they are moving—on foot, in a car, on a train or trolley, in a boat or on a plane. When the device and product are within a given distance, the user computing device 164 is approaching or within the sales environment location. For walking a distance of 10-50 feet can be used. In a shopping mall a larger distance of 50-200 feet can be used. While driving a distance of 500 to 1000 feet can be used to trigger the user computing device 164 to send a message to the user alerting him to an opportunity to learn more about a product. In other implementations, time separation can be used instead of distance. The relative speed of the user computing device 164 with respect to a sales environment location can be determined by calculating the change in distance between the user computing device 164 and the sales environment location 166, then dividing this by the elapsed time. At a calculated speed of 0.5 to 6 miles per hour the distance can be set at 10-200 feet for a user who is walking. At a calculated speed of 6.1 to 20 miles per hour the distance can be set to 500 to 1000 feet for a user driving slowly. At calculated speeds of 25-60 miles per hour, the distance can be set to 2000-1000 feet to allow adequate reaction time for the user.

In other implementations, the user computing device 164 can cache locations for sales environments where the products of interest are sold from the product location database 128 and rely primarily or solely on locally stored data. The user computing device 164 can locally apply the distance ranges described above to determine if it is approaching a sales environment where the product of interest is sold.

In a hybrid implementation, the user computing device 164, rather than sending its location data at intervals of its choosing, can wait until it receives requests for this data from the location mediation server 116, which can then use the response to calculate the location of the user computing device 164. When the device 164 is approaching a sales environment 166 that sells the product of interest 162, the location mediation server 116 can send a message to the device 164. The message can display a user alert that presents opportunities to the user to learn about the product: nearby demonstration, local product expert, live online chat session, help desk or salesperson.

In an alternate enhanced implementation, the user may establish rules that determine acceptable response delivery vehicles for the message, e.g. “If no human is available then I can accept a document but not a live chat.” Another example of a rule is for the user to specify that he has a technical question and therefore only wishes to be contacted by a product expert. Another example of a rule and acceptable response delivery vehicle may be for the user to specify that he wants to see a video of a product demo. In this case, the video is the acceptable response delivery vehicle that contains the response to the user's request.

Rules may also be used to limit the number of messages or alerts sent to a user. For example, a user may specify that he will only accept alerts when on-site in a sales environment and that he will only accept a limited number of messages per day. This mitigates the problem of overloading the user with too much information at too many different times.

In another implementation, purchase incentives may also be included, such as discount coupons or reward points. The user may also opt-in to have information from his record of product interest sent to a salesperson that can help him. For instance, the user can save time at a car dealership by providing information that describes cars he is interested in purchasing and desired options such as color, engine size, wheel selection and trim package.

In another implementation, the user computing device 164 can detect its approach to a product at a sales location using peer-to-peer communication. A Wi-Fi access point (WAP) in a large department store is one example. The user computing device 164 communicates with the WAP and feeds its MAC address (a unique hardware address assigned to the WAP) to the location mediation server 116, which can verify the location of the WAP via the product location database 128 and send a message to the user communication device 164 indicating that it is in a sales environment 166. Other proprietary location signaling beacons are emerging from manufacturers such as Nokia.

In another implementation, the user computing device 164 can use near field communications (NFC) technology and the like to detect its proximity to a sales environment. For instance, the device 164 can read an RFID tag that corresponds to a sales environment location 166 at which the product of interest 142 is sold. In this case the RFID tag can be passive since it is read by the user computing device. An active NFC device at a sales location can communicate with both the location mediation server 116 and the user computing device 164, it can detect the presence of the user computing device when it is in a range of one inch to three feet, and use an Internet connection to contact location mediation server 116 and perform an automatic check in for the user at the corresponding sales location.

After the user computing device 164 is triggered by proximity to a sales location, the application 165 can communicate with the product location server 128 to find out what opportunities are available in the sales environment for the user to learn about the product. It can then present these opportunities to the user as alerts directly from the application, email messages, text messages and voicemails.

For instance, if a user 162 wants to purchase a new car and is in the proximity of a car dealer, then the application 165 can contact the product location database to verify that the dealer is currently open and has the car the user wants. The application 165 can then alert the user that the dealer has the car which the user wants and even provide specific directions if they are available from the product location server. In this case, the user may have the opportunity to interact with the car by seeing it, touching it and perhaps driving it.

In another implementation, the user computing device 164 can detect proximity to an exemplar product 174, 176 or 178 by frequently sending its location to the location mediation server 116, which can determine the distance between the user computing device 164 and the exemplar product 174, 176 or 178. When the user computing device 164 and an exemplar product are within a threshold distance, an alert can be presented to the user 162 via the application 165. The alert can indicate the presence of the nearby exemplar as an opportunity to learn about the product of interest. The threshold value can be preset at a fixed number, e.g. 100 feet, or it may be dynamically determined based on the location and movement speed of the user computing device, which can be determined in real time by either the application 165 or the location mediation server 116.

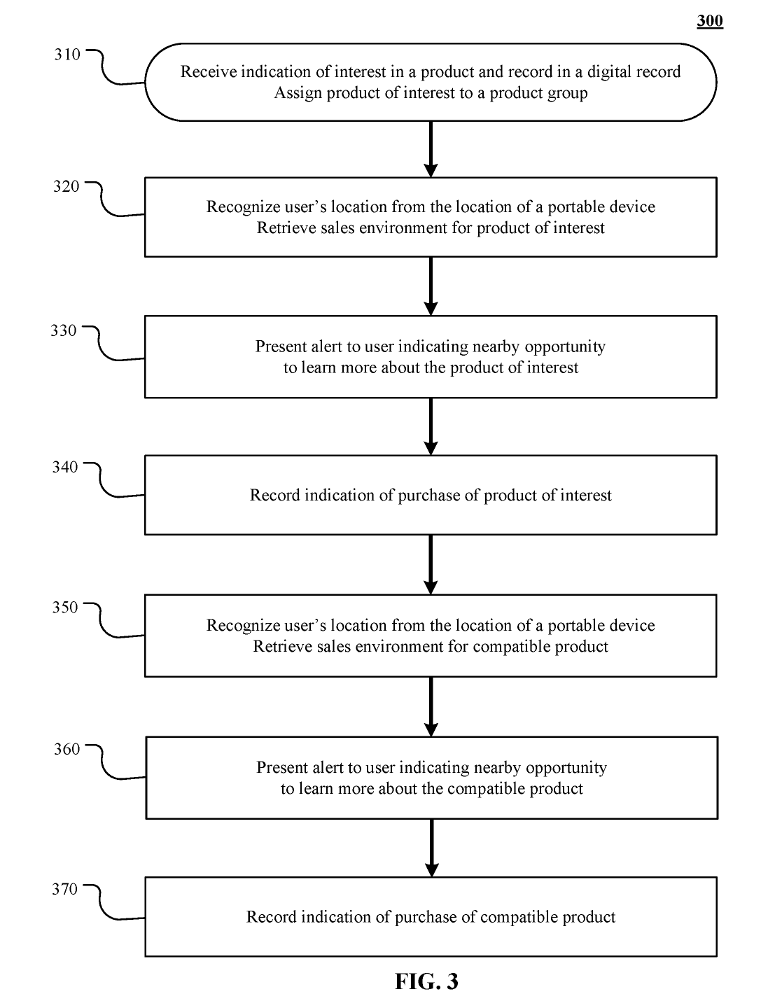

FIG. 3 is a high level flowchart 300 of a series of processes from an indication of interest in a product through purchase and service. Other implementations may perform the steps in different orders and/or perform different or additional steps than the ones illustrated in FIG. 3. For convenience, FIG. 3 will be described with reference to a system of one or more computers that perform the processes with one or more databases. The system includes one of the components described above with reference to FIG. 1.

Steps 310-330 illustrate a pre-sales process leading up to the purchase of a product in step 320.

At step 310, the system receives an indication of interest and assigns the product to a product group.

At step 320, the system recognizes a user's location as indicated by a mobile user computing device and finds locations at which the product is sold 310.

At step 330, alerts are presented to a user when he is near to the product.

At step 340 the product purchase database records that the user purchased the product.

Steps 350-370 include similar steps for a post-sales process.

At step 350, the system recognizes a user's location as indicated by a mobile user computing device and finds locations at which a compatible product is sold.

At step 360, alerts are presented to a user when he is near to the product.

At step 370, the product purchase database records that the user purchased the compatible product.

A more detailed explanation of these steps follows.

The indication of interest in step 310 can occur as a registration of interest in a product or be inferred from an online browsing session, a scan of a barcode or 2-D code, an interactive voice response system or another opt-in process. The interest database 112 saves the indication of interest as a digital record and the product is assigned to a product group as shown in FIG. 2.

The application 165 running on the user computing device 164 recognizes the user's location within a sales environment in step 320 and retrieves information about the sales environment from the product location database 128. If the product of interest is found within the sales environment, then in step 330, the application 165 alerts the user 162 to the product's presence. Further, since the application 165 can access a product location database 128, it can obtain information regarding opportunities in the sales environment for the customer to learn more about the product. Alternatively, the product information can be cached in whole or in part on the user computing device 164. The application 165 can present the opportunities in step 330, such as a nearby demonstration or sales representative, to the customer, along with their location in the sales environment if that information is available. Other opportunities may be presented to the customer as well including incentives like discounts, rewards points and similar special offers.

The purchase database records a record of the user's purchase of the product as a digital record in the product purchase database 148 in step 340.

In step 350, the user computing device number 165 in FIG. 1 communicates with the location mediation server 116 and the product location database 128 to find nearby compatible products. These include products that can work with the originally purchased product 162 in some way. For instance, a full-featured surround sound receiver is compatible with a user's newly purchased video system. Another example is a special dishwashing detergent on sale for use with a newly purchased dishwasher. Opportunities to learn about these are then located and presented by the user computing device 164 to the customer in step 350.

The correlation of the locations of the user computing device 164 and a compatible product can be done by either the location mediation server 116, the user computing device 164 using the information available in the product location database 128, or a combination in which the location mediation server 116 requests location information from the user computing device 164. As an example, if an indication of purchase in the product purchase server 148 that shows a user 162 has purchased a new dishwasher, the product location database may show that a compatible product is a recommended detergent on sale. When the location of the user computing device 164 is verified by the location mediation server 116 to be within a sales environment 166 which sells the detergent, the application 165 can communicate with the product location database 128 to find out about the detergent and alert the user 162 via the application 165 to the presence of the detergent in the sales environment. Another way to implement this is to download an RFID code of the detergent from the product location database 116, which can maintain product location information as well as product feature information, to the user computing device 164. The user computing device may then use NFC technology to detect an RFID tag present on or near the detergent as the user 162 passes within range of the RFID tag, such as within three feet. Longer range, up to 300 feet, RFID tag communication is possible with active RFID tags, which have their own power source.

In step 370 the purchase database 148 records the indication that the customer has purchased a compatible product. Additional opportunities for compatible products may be presented to the customer whenever the location aware application discovers them.

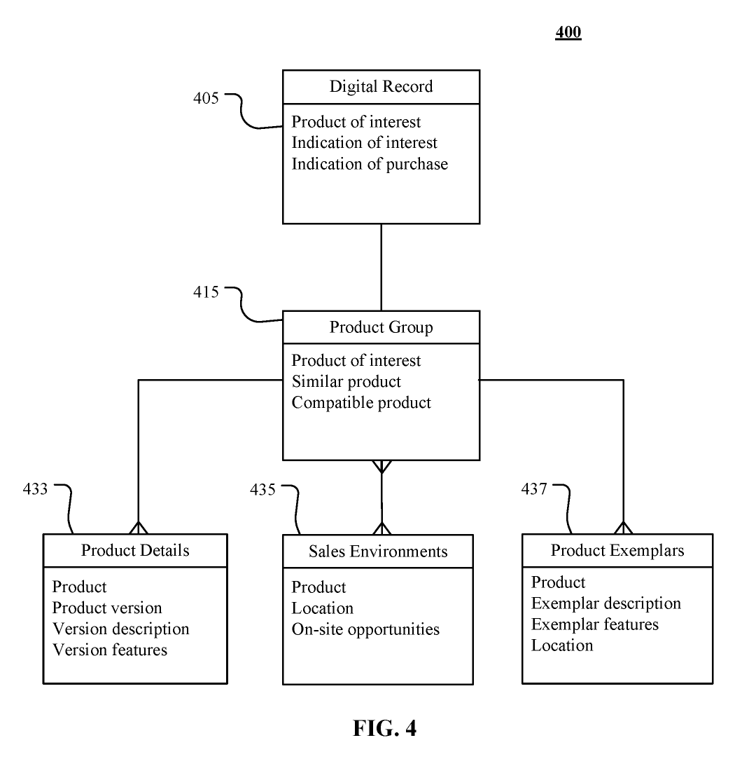

FIG. 4 is an example database schema 400 that shows the classes as blocks, with the name of the class at the top portion of each block. The main portion of each block contains the class members. The classes in this schema are equivalent to tables in a relational database with the class members being equivalent to fields.

Digital record 405 tracks the product of interest, the customer's indication of interest and their indication of purchase.

The product of interest is assigned to a product group 415 using a one-to-one relationship. In an alternate embodiment, a one-to-many relationship that assigns multiple product groups to a single product of interest may be used.

Each product group includes at least the product of interest, and may contain similar or equivalent products as well as compatible products. The product members in classes 433, 435 and 437 may refer to any type of product in the product group 415. Additional products related to the product of interest may also appear in the product group class. Any of these products may have specific details and therefore a many-to-many relationship is shown between the members of the product group class 415 and the product details class 433. Details may include but are not limited to the product version, a description of the version and features of the version.

Likewise, multiple sales environments 435 may exist for any of the products in the product group class 415. Hence, a one-to-many relationship is shown here. Each sales environment may have a location and on-site opportunities for the customer to learn more about the product of interest, a similar product or a compatible product. Similarly, many product exemplars 437 may exist for any product in the product group class 415. Each product exemplar may have a description and features as indicated.

The information gathered and stored in online databases via the network 145 in the previous figures includes the details of a customer's journey from initial exposure through interest to purchase of a product. It can include a reference to any ads that were presented to the customer and a URL or other object that customer used to register his initial interest. It can include locations, both physical and online, that the customer visited to learn more about the product. After sale of the product, the manufacturer has many opportunities to track the product online through its lifecycle online. The manufacturer can provide useful ads for follow-on products to the user and track the effectiveness of the ads. The next figure illustrates tracking the product and ads online after sale.

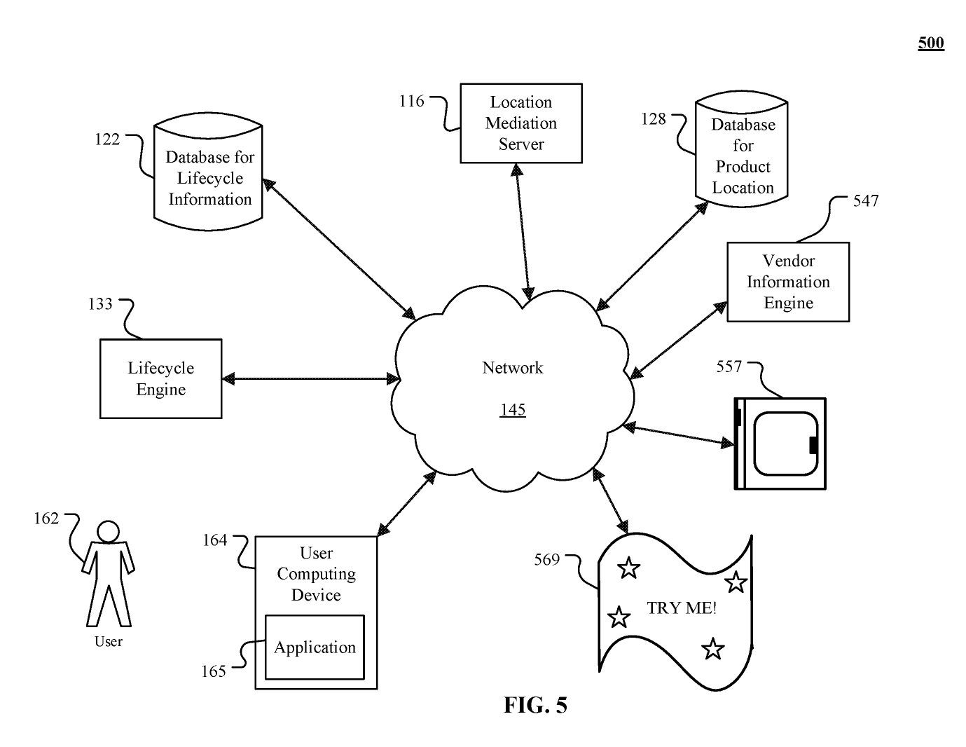

FIG. 5 shows an example of objects connected to the networked environment 100 described in FIG. 1 that can respond to requests from other components in the environment. Their lifecycle can be tracked since they are connected via a network 145. The lifecycle engine 133 can perform the lifecycle tracking function, the lifecycle information is stored in a database 122 and a vendor engine 547 provides information to and from a vendor of a connected object.

Objects may also be able to send requests and status information that can be stored on other databases in the environment or communicated to other objects in the environment. In addition, these objects can be intangible, for example, an ad for a marketing campaign.

Objects can be “dumb” and simply labeled with a barcode that a customer can scan to request more information if physically present as described above. They can also be “smart” if they include, for example, a CPU with dedicated storage and memory. In some implementations, an object may include its own smart communications module which is connected via a network 145 to a location mediation server 116 which can alert a nearby customer to its presence.

Objects can also be tangible or intangible. Tangible objects indicated in the example shown on FIG. 5 include a user computing device 164 and a washing machine 557. An example of an intangible smart object is a banner ad on a webpage, shown as 569 in FIG. 3, which can detect a user's interest via an action, for instance a mouse click, on the web browser interface. It can then log the action and respond to it by displaying another web page with additional information. The user's response to the ad can also serve as an automatic registration, if the user has opted-in, and any following webpages can be tracked.

The advantage of having a smart object is that it can, for example, communicate its status dynamically to other components in the environment via its communications link. Examples of statuses include: Available/Unavailable (on/off, ready/busy), In range/Out of range (via GPS), Active/Inactive (disabled/enabled), Broken/Fixed, Under warranty/Out of warranty. The status of an object can change as it progresses through its lifecycle. The lifecycle of an object can be captured, stored and tracked using a lifecycle engine 133 and an accompanying database 122.

To enable accurate tracking, an object may be assigned a fingerprint in the form of a unique ID. Using a washing machine as an example, the lifecycle status described in FIG. 1 progresses from initial interest to purchase to service. In this example, these statuses are obtained indirectly from the user and a POS terminal. When the status transitions to service, a unique ID such as a serial number can be assigned to track the washing machine. In another implementation, the washing machine may be barcoded and a user in a sales environment may use a smartphone to scan the barcode, register interest and request information.

In another implementation the washing machine 557 is a smart object and it can communicate with the lifecycle engine 133 which accesses the database for lifecycle information 122. The database can store its status and other relevant information, including recommended types of detergents, a history of service calls and warranty details. One advantage of being a smart object comes into play after the user purchases the washing machine 557: it can update its status dynamically. For instance, if it detects a problem it can log that status in the lifecycle information database via the lifecycle engine. In another implementation, the lifecycle engine can be setup to notify the user of the problem through the user computing device 164. Given access to the user's calendar and warranty information it could also automatically schedule a warranty repair call at the user's convenience and notify the user of this action. In this case, the user would have opted-in to have the lifecycle engine track the washing machine lifecycle and automatically schedule warranty repairs.

In another example, a smart washing machine 557, connected via a network 145 to a lifecycle engine 133, can enter a “broken” lifecycle in which it can provide all of its diagnostic data to the vendor information engine 547 via an online connection. In a more enhanced example, the vendor information engine can perform a remote diagnostic on the washing machine or request the washing machine to perform its own self-diagnostic. The results can be used to automatically order necessary parts and schedule a repair call at the convenience of the user.

After the washing machine is repaired, it can re-run a self-diagnostic and update its lifecycle status to “fixed” using its network connection to the lifecycle engine 133. To complete the process, a survey can be emailed to the user to collect feedback on the process in order to continually improve customer service and satisfaction.

The foregoing example relates to a tangible object, the washing machine 557. The notion of lifecycle tracking and management can also be applied to intangible objects like an advertising campaign.

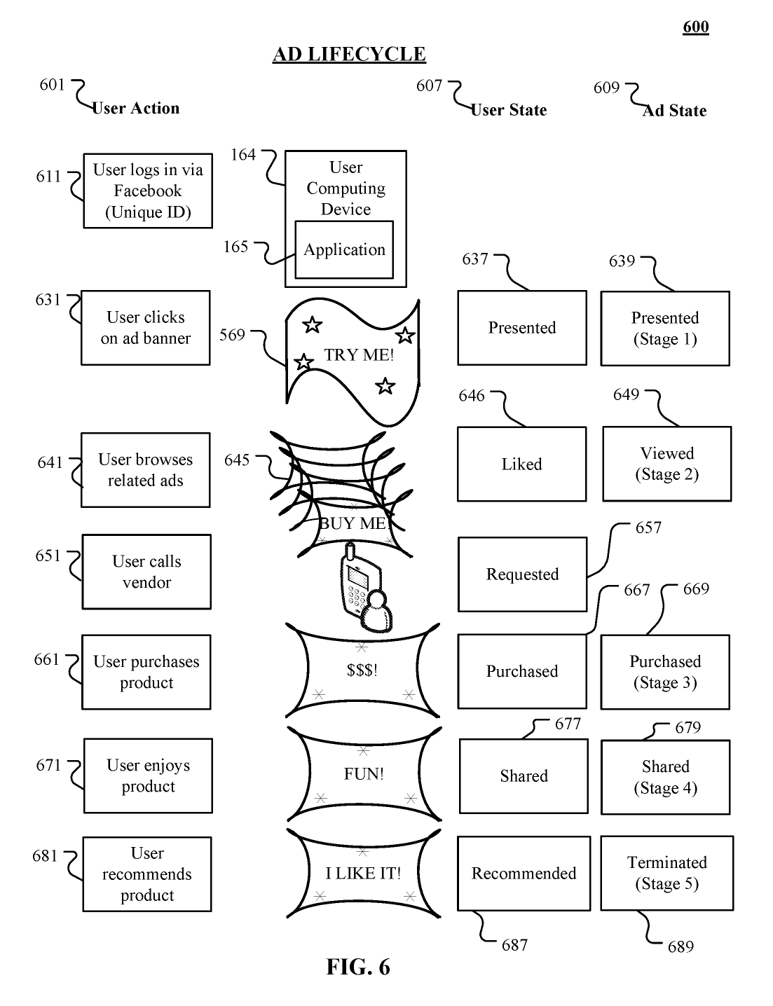

Object 569 is an ad campaign on a webpage—a smart, intangible object that communicates via the network 145 in FIG. 1 with a lifecycle engine 133 and accompanying database 122. Being an object implemented in software allows detailed lifecycle tracking and connectivity to other related objects. If the ad 569 is part of a campaign, it and all its subsequent ads, shown as a stack of ads 645 in FIG. 6, may be tracked across many users to measure its effectiveness in generating purchases of its associated products and services. All the ads in an online ad campaign can be fingerprinted with a unique ID, registered with each person who interacts with each of them and tracked with that person's unique ID.

To satisfy privacy concerns, an opt-in option can be provided to users wishing to benefit from having their actions tracked with respect to a particular service or product. Such benefits may include being pushed relevant information, alerted to opportunities to learn more about the product when they are in a sales environments and receiving special discounts and incentives.

FIG. 6 is an example of how the tracking process can be applied to ad campaign 569 in FIG. 5 to follow a user's progress from initial interest to purchase to use and thence to recommendation to a friend. Throughout the process, the online ad object and related objects communicate with and are tracked via the lifecycle engine 133 in FIG. 5. For convenience, an ad may refer to any materials that include marketing and/or sales materials. In other implementations, ads may not have the same content or material as those described in this application and/or may have other/different content or material instead of, or in addition to, those described in this application. In some implementations, ads may refer to online advertisements, informational brochures, articles and/or demos relevant to products that may be purchased.

The tracking process can be used to measure the success of the ads in various ad campaigns along with measuring overall success of the campaigns. For instance, success can be measured in terms of customer loyalty, repeat business, lead generation through channels like Facebook, Twitter, and the like. In some implementations, different forms of customer sharing and recommendation indicators can be used to measure the success of ads and/or ad campaigns.

The tracking can be done using fingerprinting that can assign unique IDs to the objects being tracked, which can include tangible or physical objects and intangible objects. In some implementations, examples of lifecycle objects can include household appliances, web-based ads, online registrants to the ads, etc.

In some implementations, objects can be associated with a geographic location such as “Times Square” or an online location or URL such as “www.timessquare.xyz.” In the case of ads and incentives, this can result in efficient identification of locations that produce more sales than others or meet pre-assigned criteria set by the ad campaign administrator(s).

An object can have many associated states referred to as “stages.” In some implementations, these stages can be modified and customized, depending on the object. FIG. 6 illustrates stage modification and customization at user state 607 and ad state 609, both of which correspond to a user action 601. In this example the user progresses through six states from presented 637 to recommended 687, while the ad progresses through five states from presented 639 through terminated 689. In other implementations, the states may not have the same name during the progression. In some implementations, the user may have a state but the ad may not have a corresponding state or vice-versa.

When a user first logs in via an application 165, a unique ID can be assigned to the user. In some implementations, application 165 can be a web browser running on a user computing device 164 using an online social network such as Facebook. In some implementations, the unique ID can be the Facebook ID of the user. In other implementation, the unique ID can be generated from a user's Facebook ID using a hash algorithm to produce a unique number.

In some implementations, the ad campaign lifecycle can begin when the user selects the ad banner screen object 569. The ad banner can include a pre-assigned unique ID. When the user selects an ad banner at user action 631, the technology disclosed can update the object lifecycle to presented stage 637 (stage 1) to indicate that it was presented to the user. Similarly, the user state 607 can also be set to presented state 639.

When a user is browsing 641 related ads 645 and selects a screen object such as “like”, “choice”, etc., the technology disclosed can change the user state 637 to liked 646 and further update the ad state to viewed state 649 (stage 2) to indicate that the ads were viewed by the user.

When a vendor 651 is called, the technology disclosed changes the user state 607 to requested state 657, which can indicate that the user requested more information. In some implementations, the ad state may not be updated at this time.

When the product is purchased at 661 the user state 607 is updated to purchased 667. The ad state can indicate that the product was purchased by progressing to purchased 669 (stage 3).

In user action 671, the user can share his experiences with friends using short messages on his smartphone, which can allow photos of his experiences to be shared. Other communication channels can be used including Twitter, Facebook, email, etc. The sharing is visible to the lifecycle engine which can track user sharing and update the user state 677 and the ad state 679 to shared (stage 4).

When the product is recommended at 681 to a friend, the user state 607 updates to recommended 687. The ad state has now completed its full lifecycle and changes to terminated 689 (stage 5). Alternatively, the ad state may be continued by registering it to the user's friend and repeating the ad lifecycle.

Individual statistics for each ad in an ad campaign can be collected together and analyzed to assess which ads, or sequence of ads, resulted in the best conversion (to purchase) rates.

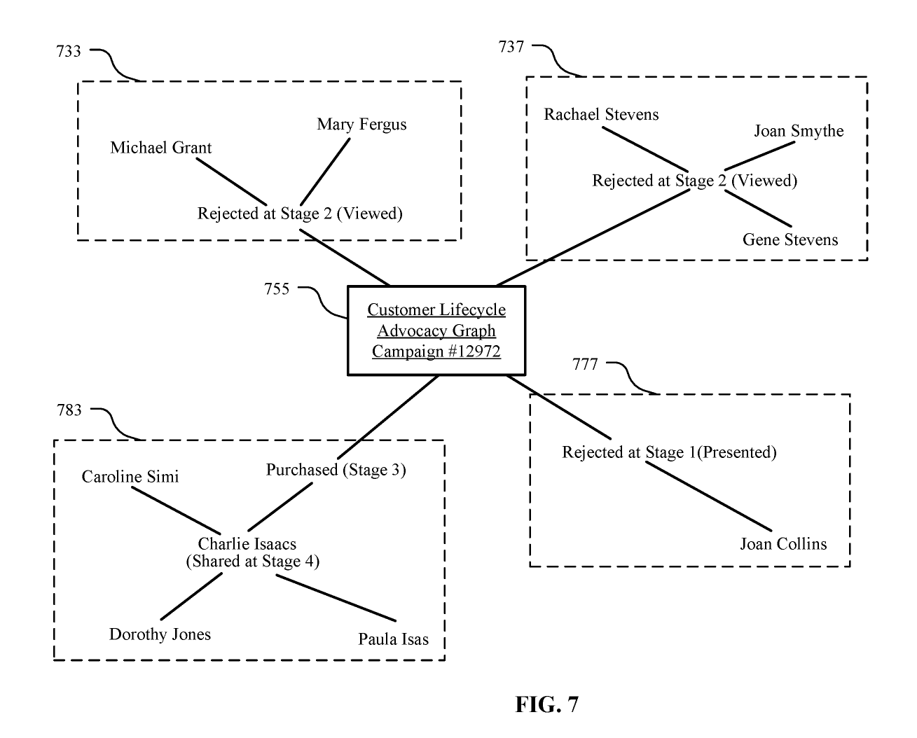

When multiple recommendations are connected together it is possible to form a graph showing how the ad generated interest through a first person who purchased the product and recommended it to one or more friends, who then recommended it to yet other friends. Such a graph, as shown in FIG. 7, can be used to show the effectiveness of a single ad or a collection of ads in an ad campaign.

FIG. 7 is an example graph that tracks the interactions and responses of four people to an ad campaign similar to the one described in FIG. 6. It tracks the lifecycle of the ad campaign in terms of customer behavior, using the stages described in the example of FIG. 6: presented, viewed, purchased, shared and terminated.

FIG. 7 illustrates a customer lifecycle advocacy graph 755 for an ad campaign. The customer lifecycle advocacy graph 755 describes a thread based progression of user experiences of various ad campaigns. Furthermore, it represents the paths followed by users culminating in an actual purchase. FIG. 7 includes three dotted rectangles 733, 737 and 777, which represent three instances of viewers' rejection of or lack of response to an ad campaign. The dotted rectangle 783 shows a first user's purchase and referral of three other users who bought the same product as the first user. In this example, a customer loyalty metric may be calculated for the first user, Mr. Isaacs. One implementation of a customer loyalty metric can be based on the number of purchases or the money spent on purchases. Another implementation may be based on the number of referrals. Yet another implementation may be based on the kind or type of purchases, for instance online purchases versus in store purchases or full price purchases versus discount purchases.

An ad campaign's success with a first user can be used to make sales based deductions about the first user's demographics. When an ad campaign succeeds with a first user, the technology disclosed can analyze the first user's demographics to discover the particular ad content that is likely to enhance user engagement leading to purchase. These analytics can then be extended to create more effective and focused ads directed at other users that share the same demographics as the first user.

The following example illustrates how different lifecycle objects can be used to track an ad campaign through its various stages. Other lifecycle objects can be devised for different product lifecycles that have fewer or more stages and different tracking requirements.

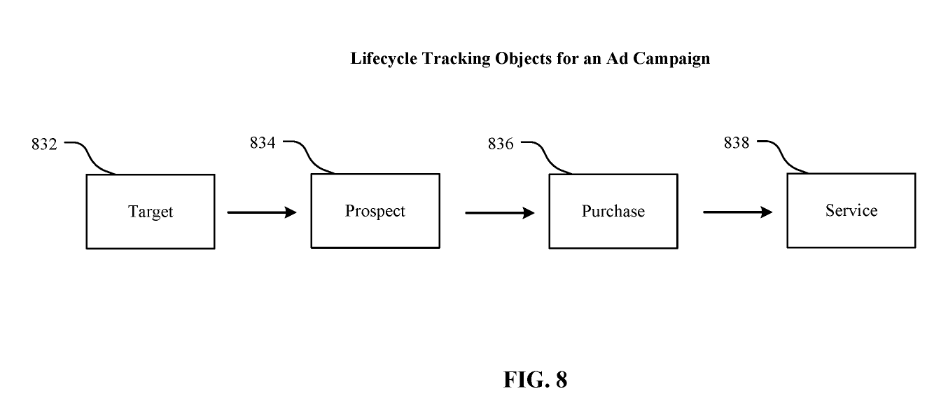

FIG. 8 is an example of some of the different objects that can be used to track the lifecycle of an ad campaign from initial targeting to identifying prospects and converting them to customers who purchase a product and related services.

The campaign begins with several widely targeted online ads oriented towards different customer demographics. A target object 832 can be used to track the ads, including related material, a user views during this stage. After a potential customer interacts with several widely targeted ads, these ads are merged and transformed into a prospect object 834 which can be tied to a more narrow series of ads and promotional material.

The technology disclosed can also include ad click-through histories that can be captured and evaluated. In some implementations, these ad click-through histories can follow the progression of ads as viewed by a prospective customer. A progression can proceed from general ads focused on branding and market positioning to ads focused on a particular product category, and finally to model specific ads as a prospect converges with user preferences. These user preferences can be stored in a prospect profile. Additionally, click-through histories of multiple customers can be correlated to find the most frequent click through history, which can provide a measure of most effective ads and/or ad sequences.

An example of the above-described ad click-through histories can be illustrated when a user researches a new car. While looking at ads for purchase purposes, the user may decide on a particular type of car based on his or her preferences. For instance, the user may purchase a sports car for driving pleasure or a mini-van for transporting his family. In some implementations, user's search may include browsing several versions of the chosen car that can have different features and price points. In other implementations, the technology disclosed can deduce user preferences based on the above-described search process such as price, functionality, color, comfort, serviceability, fuel economy, style and other attributes associated with a car purchase.

In some implementations, a user's behavior during the search can be captured in a target lifecycle tracking object 832. When the user views more narrowly targeted ads to learn about a product, various objects can be created such as a new targeting object, a prospect lifecycle tracking object 834. The prospect object may inherit information from the initial target object. In other implementations, the initial target object can be extended into a prospect object by adding additional information.

Various kinds of advertising material can be tracked using lifecycle tracking objects. Examples of lifecycle tracking objects can include target and prospect objects 832 and 834. In some implementations, information related to comparison shopping that includes direct feature-to-feature comparison can be very useful to manufacturer that are trying to narrow their product line to the most profitable items. The comparison information can help users converge their preferences while enhancing the likelihood of a purchase.

In some implementations, the technology disclosed can track user reviews and online sites that publish online customer reviews. It can further evaluate their contribution to a final sale.

When a product is purchased, the prospect object 832 is transformed or converted into a purchase object 836 that can be extended to include specific attributes of the product that was purchased such as model, serial number, color and special features. Following purchase, a service object 838 can be created from a transformed purchase object. The service object 838 can be an extension of the purchase object by including attributes such as warranty tracking, availability of extended warranties, automatic servicing for the product (e.g., automatically shipping water filters to the user every six months for a refrigerator), repair history, customer contact information and user notification of problems. The service object can persist for the remaining useful lifetime of the product, and can offer follow-on sales opportunities, extended warranties and the like.

### Particular Implementations

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

In one implementation, a method is described for automatically anticipating and responding to a customer's needs given an indication of interest in a product. This implementation includes receiving an electronic record of a customer's interest in a product and assigning the product of interest to a product group; then building a digital record of the customer's interest in the product and efforts to become informed about the product and the product group. The implementation further includes recognizing from the location of a portable device, such as a smartphone, when the customer is approaching or located within a sales environment in which the product is for sale and providing alerts to the customer indicating opportunities within the sales environment to learn more about at least the product.

This method and other implementations of the technology disclosed can each optionally include one or more of the following features.

In one implementation, the method includes receiving a customer opt-in and specification of how much information to receive regarding the product.

In another implementation, the method includes determining the location of the portable device based on a check-in between the portable device and a device at the sales environment.

In yet another implementation, the method further includes determining the location of the portable device based on a peer-to-peer communication between the portable device and a device at the sales environment.

In another implementation, the method further includes providing alerts to the customer based on timing that takes into account how fast the customer is approaching the sales environment.

In another implementation, the method includes receiving an indication of interest based on a customer friending a product-related social site and authorizing contact.

In another implementation, the method further includes providing alerts to the customer from a cache of sales environment-related information sent to the portable device.

In yet another implementation, a method is described for automatically anticipating and responding to a customer's needs given an indication of a purchase of a product. This implementation includes receiving an electronic record of a customer purchasing a product and identifying compatible products and building a digital record of the purchase and the compatible products. This implementation further includes, recognizing from the location of a portable device when the customer is located within a sales environment in which one or more of the compatible products are for sale and providing alerts to the customer indicating opportunities within the sales environment to learn more about at least one of the compatible products.

In another implementation, a method is described for automatically anticipating and responding to a customer's needs given an indication of interest in a product. This method further includes receiving an electronic record of a customer's interest in a product and assigning the product of interest to a product group, then building a digital record of the customer's interest in the product and efforts to become informed about at least the product. It also includes identifying one or more exemplars of the product; and utilizing a location trigger from the location of a portable device to recognize when the customer has an opportunity to interact with at least one of the product exemplars, and to responsively provide an alert to the customer indicating an opportunity to interact with the product exemplar.

In one implementation a method is described for tracking a person's engagement with a product over its sales cycle and the product lifecycle. This method includes tracking efforts to engage a person using targeting objects with unique IDs and linking the targeting objects to an identified person via a unique ID for the person. This method further includes merging and transforming a plurality of targeting objects into a prospect object when the person affirms interest in a target product, and extending and transforming the prospect object into a target object that is a purchase object when the person purchases the product. This method further includes a product instance identifier and purchase-related data for the product.

In another implementation, the targeting objects can include a service object that is transformed and extended from a purchase object and further includes warranty information.

In another method, the targeting objects can include a share object that is transformed and extended from a purchase object and further includes tracking information related to sharing experiences with a purchased product.

In another method, the tracking information from targeting objects preceding the purchase of a product can be summarized as graph showing the sequence in which a person traversed the targeting objects.

Other implementations may include a non-transitory computer readable storage media storing instructions executable on a processor to perform a method is described above. Yet another implementation may include a system with memory and one or more processors operable to execute instructions, stored in memory, perform the method as described above. This is true of each of the following implementations and will, for the sake of brevity, not be repeated.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

1. A method of tracking a person's engagement with a product over its sales cycle and the product lifecycle, including:
tracking efforts to engage a person using targeting objects with unique IDs;
linking the targeting objects to an identified person via a unique ID for the person;
when the person affirms interest in a target product, merging and transforming a plurality of targeting objects into a prospect object; and
when the person purchases the product, automatically extending and transforming a target object that is a prospect object into a target object that is a purchase object that further includes a product instance identifier and purchase-related data.

2. The method of claim 1, wherein the targeting objects include a service object that is automatically transformed and extended from a purchase object and further includes warranty information.

3. The method of claim 1, wherein the targeting objects include a share object that is automatically transformed and extended from a purchase object and further includes tracking information related to sharing experiences with a purchased product.

4. The method of claim 3, wherein the tracking information from targeting objects preceding the purchase of a product is summarized as graph showing a sequence in which a person traversed the targeting objects.

5. A method of tracking a person's engagement with a product over its sales cycle and the product lifecycle, the method including:
creating a plurality of targeting objects for a person in response to detecting the person's engagement with a plurality of widely targeted ads of an online ad campaign, wherein each of the targeting objects have unique IDs;
linking the targeting objects to the person using a unique ID of the person;
responsive to detecting the person's progression from engaging with at least one widely targeted ad to engaging with at one narrowly targeted ad of the online ad campaign, automatically merging and transforming the plurality of targeting objects into a prospect object;
responsive to detecting the person's progression from engaging with the narrowly targeted ad to purchasing a target product, automatically extending and transforming the prospect object into a purchase object that further includes a product instance identifier and purchase-related data; and
generating for display a summarized graph depicting progression of the person traversed from the targeting objects to the purchase object.

6. The method of claim 5, wherein the person's engagement is detected using click-through history of the person.

7. The method of claim 5, wherein the prospect object is created when the person affirms interest in the target product.

8. The method of claim 5, further including:
responsive to detecting the person's progression from purchasing the target product to engaging with service oriented targeted ad of the online ad campaign, automatically extending and transforming the purchase object into a service object that includes one or more service attributes of the target product.

9. The method of claim 8, wherein the service attribute is at least one of warranty tracking, availability of extended warranties, automatic servicing for the target product, repair history, customer contact information, and user notification of problems.

10. A non-transitory computer readable storage medium impressed with computer program instructions to track a person's engagement with a product over its sales cycle and the product lifecycle, the instructions, when executed on a processor, implement a method comprising:
tracking efforts to engage a person using targeting objects with unique IDs;
linking the targeting objects to an identified person via a unique ID for the person;
when the person affirms interest in a target product, merging and transforming a plurality of targeting objects into a prospect object; and
when the person purchases the product, automatically extending and transforming a target object that is a prospect object into a target object that is a purchase object that further includes a product instance identifier and purchase-related data.

11. The non-transitory computer readable storage medium of claim 10, wherein the targeting objects include a service object that is automatically transformed and extended from a purchase object and further includes warranty information.

12. The non-transitory computer readable storage medium of claim 10, wherein the targeting objects include a share object that is automatically transformed and extended from a purchase object and further includes tracking information related to sharing experiences with a purchased product.

13. The non-transitory computer readable storage medium of claim 12, wherein the tracking information from targeting objects preceding the purchase of a product is summarized as graph showing a sequence in which a person traversed the targeting objects.

14. A non-transitory computer readable storage medium impressed with computer program instructions to track a person's engagement with a product over its sales cycle and the product lifecycle, the instructions, when executed on a processor, implement a method comprising:
creating a plurality of targeting objects for a person in response to detecting the person's engagement with a plurality of widely targeted ads of an online ad campaign, wherein each of the targeting objects have unique IDs;
linking the targeting objects to the person using a unique ID of the person;
responsive to detecting the person's progression from engaging with at least one widely targeted ad to engaging with at one narrowly targeted ad of the online ad campaign, automatically merging and transforming the plurality of targeting objects into a prospect object;
responsive to detecting the person's progression from engaging with the narrowly targeted ad to purchasing a target product, automatically extending and transforming the prospect object into a purchase object that further includes a product instance identifier and purchase-related data; and
generating for display a summarized graph depicting progression of the person traversed from the targeting objects to the purchase object.

15. The non-transitory computer readable storage medium of claim 14, wherein the person's engagement is detected using click-through history of the person.

16. The non-transitory computer readable storage medium of claim 14, wherein the prospect object is created when the person affirms interest in the target product.

17. The non-transitory computer readable storage medium of claim 14, implementing the method further comprising:
responsive to detecting the person's progression from purchasing the target product to engaging with service oriented targeted ad of the online ad campaign, automatically extending and transforming the purchase object into a service object that includes one or more service attributes of the target product.

18. The non-transitory computer readable storage medium of claim 17, wherein the service attribute is at least one of warranty tracking, availability of extended warranties, automatic servicing for the target product, repair history, customer contact information, and user notification of problems.

19. A system including one or more processors coupled to memory, the memory loaded with computer instructions to provide a recovery strategy for a stream processing system, the instructions, when executed on the processors, implement actions of claim 1.

20. A system including one or more processors coupled to memory, the memory loaded with computer instructions to provide a recovery strategy for a stream processing system, the instructions, when executed on the processors, implement actions of claim 5.
